(19) United States
(12) Patent Application Publication
(10) Pub. No.: US 2014/0129188 A1
(43) Pub. Date: May 8, 2014

(54) SYSTEM AND METHOD FOR ANALYSIS OF SEISMIC IMAGES

(71) Applicants: Philip Stephen Schultz, Bellaire, TX (US); Daniel Paul Johnson, Houston, TX (US)

(72) Inventors: Philip Stephen Schultz, Bellaire, TX (US); Daniel Paul Johnson, Houston, TX (US)

(73) Assignee: Chevron U.S.A. Inc., San Ramon, CA (US)

(21) Appl. No.: 13/670,878

(22) Filed: Nov. 7, 2012

(51) Int. Cl. G06F 17/00

(52) U.S. Cl. CPC G06F 17/00
USPC 703/2

(57) ABSTRACT

A method for modeling illumination in a seismic survey of a subsurface region using a velocity model thereof includes specifying locations for a plurality of seismic shots, specifying locations for a plurality of seismic receivers, specifying a source radiation pattern for each source, tracing each ray from a reflection surface, computing an energy value for each ray using a Fresnel zone defined at a receiving surface and defined for a single frequency, and repeating the tracing and computing for each shot.

### TECHNICAL FIELD

The present invention relates to seismic imaging of subsurface features.

### BACKGROUND

In hydrocarbon exploration, seismic imaging may be used to determine likely locations for exploitable resources. Planning for a seismic imaging project requires modeling the expected velocity and reflection response in the subsurface region under study. Modeled predictions may be used to generate the illumination pattern for the imaging operation. Methods of modeling illumination may suffer from various drawbacks relating to accuracy and/or computational burden. Thus, the inventors have determined that an improved approach to illumination modeling would be useful.

### BRIEF DESCRIPTION OF DRAWINGS

FIG. 1 is a flow chart illustrating a workflow in accordance with an embodiment of the invention; and

FIG. 2 is a map of illumination energy over a selected horizon produced using a method in accordance with an embodiment of the invention.

### DETAILED DESCRIPTION

In a seismic survey, illumination may be considered to be the seismic energy from a source or sources that reflects off of a given region of a target horizon and is returned to receivers. As will be appreciated, this means that seismic energy that is attenuated or scattered prior to reaching the reflector, energy that reflects but is not recorded, or energy that is not reflected (e.g., energy that is absorbed or transmitted) is not considered to be “illumination.”

Understanding how a selected seismic survey geometry (location of sources and receivers) acts to illuminate the subsurface allows for changes in survey design to improve the likelihood of capturing a clear image of the region under study. For example, if there is an elongated trench in the zone, it may be useful to ensure good illumination along the axis of the trench. If there are shallow reflectors that may tend to shadow deeper features of interest, it may be useful to design the survey so as to undershoot the obstacles.

In an embodiment, a ray tracing technique is used to simulate an illumination response of a reflecting surface to a specified acquisition geometry. In the simulation, an energy source has a substantially uniform distribution of emerging rays over all solid angles, so that each ray models an equal contribution of source energy. This may allow for a simplification by avoiding the requirement of explicit computation of spreading factors. At the receiving surface, a Fresnel zone is applied at the dominant frequency around the point of the arriving ray. In embodiments, the method employs the first Fresnel zone, though in principle higher order zones could be used. Receivers, each weighted by position within the Fresnel zone on the receiving surface, contribute to the energy of the ray. Receivers outside the Fresnel zone contribute zero energy for the ray and can be ignored, generally reducing the computational burden. The energy is summed to predict the illumination energy at the reflecting point of the ray.

Because Fresnel zones are used, the wave-equation response is approximated, and illumination over a reflecting horizon for a given acquisition geometry and reflecting horizon shape is predicted with good accuracy. Because the Fresnel zone calculation is performed for the receiving surface, a useful degree of accuracy is achieved without requiring excessive computational burden, which may allow for generating larger numbers of test geometries for a given project.

In an embodiment, the product of the method is a triangulated surface with computed energy value as a property of that surface. That is, each vertex of the surface may have an illumination energy value associated with it. Once this product is generated, it may be used as the basis for a survey design. More typically, a number of such surfaces, each generated for a respective set of assumptions (e.g., different realizations of the velocity model, different geometries for the design) are generated to allow design choices to be evaluated. Given the illumination product, a decision may be made regarding redesign of the seismic survey. Alternately, the illumination surface may allow a decision maker to make an informed decision regarding the sufficiency of a particular design. That is, while a different design might provide superior illumination at a greater cost, the improvement in illumination may be small compared to the increased cost.

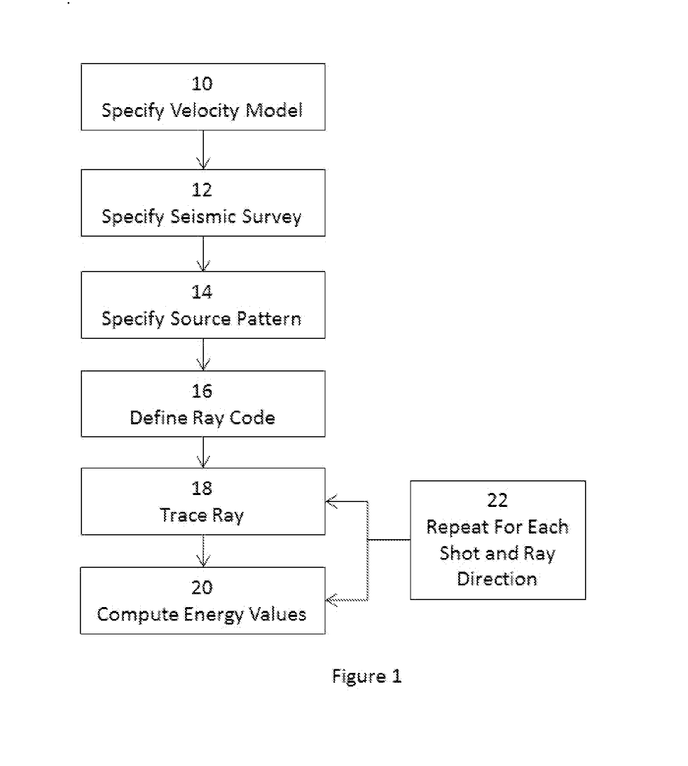

In an embodiment illustrated in FIG. 1, a workflow begins with specification of a velocity model for the subsurface region under study 10. The velocity model may include structural horizons in the form of triangulated surfaces, and velocities representing the modeled speed of seismic waves in the material present in the subsurface. For velocity models having high degrees of non-homogeneity, and in particular, where there is a high spatial frequency variation (e.g., structures having steep dip, rapidly varying geology, or other complex structures), calculated illumination may tend to be poor and many regions may be shadowed, blurred or otherwise poorly imaged.

A corresponding seismic survey is specified 12. The specification may include structural surfaces where the sources (shots) and receivers are positioned as well as X-Y coordinates for the sources and receivers. The X-Y coordinates along with the structural surfaces together define X-Y-Z locations for each source and each receiver.

A set of starting ray directions at the source (i.e., a source radiation pattern) is specified 14. The specification may include minimum and maximum inclination angles, which may be measured from the downward vertical) and a delta angle. A set of starting directions is derived so that the solid angle separating adjacent directions is uniform.

A sequence of structural boundaries with which each ray will interact is defined, along with the type of interaction 16. This sequence may be referred to as a ray code. Relevant types of interaction may include reflection, transmission, and/or mode conversion. A primary reflector corresponding to the horizon for which the illumination map is to be generated is selected.

For each shot and each ray starting direction, a ray is traced in accordance with the ray code 18, using any appropriate ray tracing approach.

For each ray that satisfies the ray code, an energy value is computed 20. Energy is determined by determining a velocity (for example, a root mean squared velocity may be used), computing a Fresnel zone radius and producing a weighted sum over all receivers within the Fresnel zone. That energy is then added to the energy totals of all vertices of the primary reflector within the capture radius of the ray's reflection point. The ray trace and energy value computation is repeated for every shot and ray takeoff direction 22. As will be appreciated, the method may provide an illumination map that approximates the actual illumination without requiring any wave equation computation, thereby greatly reducing the computational burden. An example of an implementation of the foregoing steps are described in greater detail below.

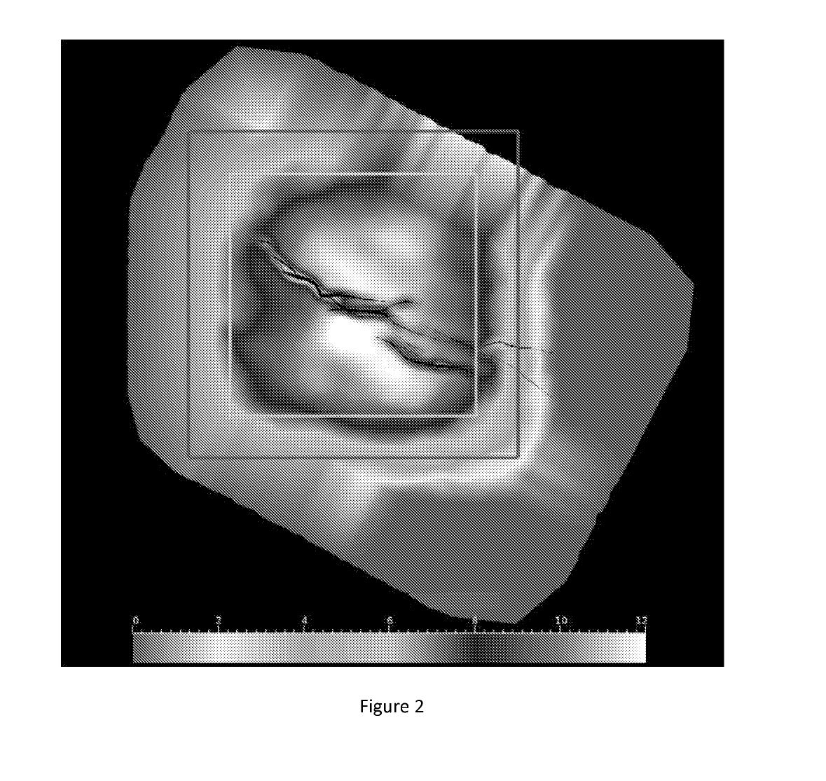

An example of such an illumination map is illustrated in FIG. 2 for a mirror wavefield. In the illustrated example, the inner rectangle is the area of interest. That is, if that portion of the horizon is sufficiently illuminated for the proposed acquisition survey geometry, that geometry is acceptable.

A root mean squared velocity is computed for a in accordance with Equation 1:

$$\text{?} = \text{?} \\ \text{?} \text{indicates text missing or illegible when filed} \qquad ( Eqn . 1 )$$

where V is the interval velocity and t is time.

A Fresnel zone radius is computed for a selected dominant frequency fin accordance with Equation 2:

$$R = \text{?} \\ \text{?} \text{indicates text missing or illegible when filed} \qquad ( Eqn . 2 )$$

The dominant frequency will generally be in the range of 8 Hz-60 Hz, and a frequency of about 25 Hz may be of particular use in typical seismic imaging applications.

The central frequency of the wavelet may be selected for convenience, and may be determined based on the spectrum of the energy source and on any attenuation and/or frequency dispersion along the travel path. As will be appreciated, other frequencies may be selected as best representing the energy of the ray. For example, where the ray's spectrum is not particularly Gaussian, a non-central frequency may better represent the energy of the ray. Likewise, because attenuation is frequency dependent and the wave will tend to lose high frequency as it penetrates deeper, for deeper horizons, a lower frequency will generally be used, while for shallower horizons higher frequencies are applicable.

The weighted sum of the receivers is calculated:

$$E = \frac{\text{?} cos \{ \frac{π * \vert P - Po \vert}{2 * R} \}}{{R}^{2}} \\ \text{?} \text{indicates text missing or illegible when filed} \qquad ( Eqn . 3 )$$

where P is the two dimensional location of a receiver and P₀ is the two dimensional location of the receiver end of the ray. As will be appreciated, a different weighting function could be used, but the above is generally a useful approach.

Finally, for each surface vertex of the reflector that lie within a capture radius, Q, E is added to its total energy using a cosine taper as a weighting function:

$$S = \text{?} \\ \text{?} \text{indicates text missing or illegible when filed} \qquad ( Eqn . 4 )$$

where q₀ is the location of the primary reflection point of the ray and q is the location of a vertex.

In an embodiment, the illumination surface may be used as the basis for image compensation algorithms (e.g., adjusting amplitudes in view of predicted illumination values).

While the disclosure relates primarily to seismic acquisition techniques where the receivers are at the surface, it may find applicability to other techniques. For example, in a vertical seismic profile in which sensors are in a borehole, the same approach may be used.

The above described methods can be implemented in the general context of instructions executed by a computer. Such computer-executable instructions may include programs, routines, objects, components, data structures, and computer software technologies that can be used to perform particular tasks and process abstract data types. Software implementations of the above described methods may be coded in different languages for application in a variety of computing platforms and environments. It will be appreciated that the scope and underlying principles of the above described methods are not limited to any particular computer software technology.

Moreover, those skilled in the art will appreciate that the above described methods may be practiced using any one or a combination of computer processing system configurations, including, but not limited to, single and multi-processer systems, hand-held devices, programmable consumer electronics, mini-computers, or mainframe computers. The above described methods may also be practiced in distributed computing environments where tasks are performed by servers or other processing devices that are linked through a one or more data communications networks. In a distributed computing environment, program modules may be located in both local and remote computer storage media including memory storage devices.

Also, a tangible article of manufacture for use with a computer processor, such as a CD, pre-recorded disk or other storage devices, could include a computer program storage medium and machine executable instructions recorded thereon for directing the computer processor to facilitate the implementation and practice of the above described methods. Such devices and articles of manufacture also fall within the spirit and scope of the present invention.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements. The use of the term “about” with respect to numerical values generally indicates a range of plus or minus 10%, absent any different common understanding among those of ordinary skill in the art or any more specific definition provided herein.

While in the foregoing specification this invention has been described in relation to certain preferred embodiments thereof, and many details have been set forth for the purpose of illustration, it will be apparent to those skilled in the art that the invention is susceptible to alteration and that certain other details described herein can vary considerably without departing from the basic principles of the invention. For example, the invention can be implemented in numerous ways, including for example as a method (including a computer-implemented method), a system (including a computer processing system), an apparatus, a computer readable medium, a computer program product, a graphical user interface, a web portal, or a data structure tangibly fixed in a computer readable memory.

What is claimed is:

1. A method for modeling illumination in a seismic survey of a subsurface region using a velocity model thereof, comprising:
specifying locations for a plurality of seismic shots;
specifying locations for a plurality of seismic receivers;
specifying a set of ray starting directions for each source;
tracing each ray from a reflection surface;
computing an energy value for each ray using a Fresnel zone defined at a receiving surface and defined for a single frequency; and
repeating the tracing and computing for each shot.

2. A method according to claim 1, wherein the specifying locations for the seismic shots and seismic receivers includes defining the receiving surface.

3. A method as in claim 1, wherein the specifying the starting ray directions comprises specifying minimum and maximum inclination angles and an angle increment between successive rays.

4. A method as in claim 3, wherein a solid angle separating successive rays is uniform.

5. A method as in claim 1, wherein the tracing each ray comprises specifying a ray code comprising a sequence of structural boundaries interacted with by each ray and a type of interaction for each boundary, and designating a reflecting horizon for which the illumination is modeled.

6. A method as in claim 1, wherein the computing an energy value comprises computing a Fresnel zone radius for a single frequency at the receiving surface for the ray; and
calculating the ray's energy as a weighted sum of all receivers within the Fresnel zone radius.

7. A method as in claim 6, further comprising:
defining a reflecting horizon for which the illumination is modeled and having a plurality of vertices;
for each vertex of the reflector lying within a defined capture radius of a ray's primary reflection point, a value equal to the product of the calculated weight and the ray's computed energy is added to its energy total.

8. A method as in claim 7, wherein the adding further comprises weighting a ray contribution based on a distance between a location of a primary reflection point of each ray and a location of the vertex.

9. A non-transitory machine readable medium containing machine executable instructions for performing a method for modeling illumination in a seismic survey of a subsurface region using a velocity model thereof, the method comprising:
specifying locations for a plurality of seismic shots;
specifying locations for a plurality of seismic receivers;
specifying a set of starting ray directions for each source;
tracing each ray from a reflection surface;
computing an energy value for each ray using a Fresnel zone defined at a receiving surface and defined for a single frequency; and
repeating the tracing and computing for each shot.

10. A medium according to claim 9, wherein the specifying locations for the seismic shots and seismic receivers includes defining a shot surface and the receiving surface.

11. A medium according to claim 9, wherein the specifying the set of ray starting directions comprises specifying minimum and maximum inclination angles and an angle increment between successive directions.

12. A medium according to claim 11, wherein a solid angle separating successive directions is uniform.

13. A medium according to claim 9, wherein the tracing each ray comprises specifying a ray code comprising a sequence of structural boundaries interacted with by each ray and a type of interaction for each boundary, and designating a reflecting horizon for which the illumination is modeled.

14. A medium according to claim 9, wherein the computing an energy value comprises:
computing a Fresnel zone radius for the single frequency at the receiver location for the ray; and
calculating the ray's as a weighted sum of all receivers within the Fresnel zone radius.

15. A medium as in claim 14, wherein the method further comprises:
defining a reflecting horizon for which the illumination is modeled and having a plurality of vertices; and
for each vertex of the reflector lying within a defined capture radius, adding energy based on the calculated weight.

16. A medium as in claim 15, wherein the adding further comprises weighting a ray contribution based on a distance between a location of a primary reflection point of each ray and a location of the vertex.

17. A system configured to model illumination in a seismic survey of a subsurface region using a velocity model thereof, the system comprising:
one or more processors configured to execute computer program modules, the computer program modules comprising:
a mapping module, configured for specifying locations for a plurality of seismic shots and specifying locations for a plurality of seismic receivers;
a ray direction configured for specifying a set of ray starting directions for each source;
a ray tracing module configured to trace each ray from a reflection surface; and
a computing module configured to compute an energy value for each ray using a Fresnel zone defined at a receiving surface and defined for a single frequency, wherein the processor is further configured to repeat the tracing and computing for each shot.

18. A system as in claim 17, wherein the ray tracing module is further configured to specify a ray code comprising a sequence of structural boundaries interacted with by each ray and a type of interaction for each boundary, and to designate a reflecting horizon for which the illumination is modeled.

19. A system as in claim 17, wherein the computing module is further configured to compute a Fresnel zone radius for the single frequency at a receiving surface for the ray; and
to calculate a ray's energy as a weighted sum of all receivers within the Fresnel zone radius.

20. A system as in claim 19, wherein the computing module is further configured to define
a reflecting horizon for which the illumination is modeled and having a plurality of vertices; and
for each vertex of the reflector lying within a defined capture radius of a ray's primary reflection point, a value equal to the product of the calculated weight and the ray's computed energy is added to its energy total.
